(19) United States
(12) Patent Application Publication
(10) Pub. No.: US 2007/0241079 A1
(43) Pub. Date: Oct. 18, 2007

(54) HIGH VOLTAGE CIRCUIT BREAKER WITH RE-FILL VALVE

(76) Inventors: David S. Johnson, Greensburg, PA (US); Daniel C. Schiffbauer, Uniontown, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/279,596

(22) Filed: Apr. 13, 2006

(51) Int. Cl. H01H 33/88

(52) U.S. Cl. 218/66

(57) ABSTRACT

A circuit breaker assembly includes a puffer chamber having a nozzle extending from an end, a vent located at or near the end of the puffer chamber, and a vent seal movably positioned over the vent. The vent seal prevents gas from escaping through the vent when the puffer chamber is under pressure, and it permits gas to enter the puffer chamber when the puffer chamber is not under pressure.

### BACKGROUND

1. Technical Field

The disclosure contained herein generally relates to the art of high-voltage circuit breakers and particularly to gas blast high voltage interrupters.

2. Description of the Related Art

Medium and high voltage circuit breakers are mechanical devices designed to interrupt the delivery of medium and high currents in a system using contacts that touch each other when current passes. The contacts may be separated to interrupt the current. A high voltage circuit breaker may be a breaker designed to be operated at one or more voltage levels of approximately 69 kilovolts (kV) or higher, or between about 50 kV and about 800 kV. A medium voltage circuit breaker may be, for example, a breaker designed to operate at one or more voltage levels between 0.5 kV and about 50 kV. Other voltages are possible.

To minimize the arc that may occur during separation, the contacts of a medium or high voltage circuit breaker may be cooled with a blast of pressurized gas, such as sulfur hexafluoride, so that the arc may be extinguished. A typical gas blast circuit breaker may include a gas-blast interrupter module that encompasses the electrical contacts that perform the circuit interrupting function. In circuit breakers of this type, a dielectric gas such as sulfur hexaflouride (SF₆) is used as an interrupting medium. The deionizing effects of the gas help to extinguish high current arcs across the circuit-breaker contacts. Gas blast circuit breakers generally include both a piston-driven chamber in communication with a thermal blast chamber in order to deliver the pressurized gas across the arc. Gas blast circuit breakers are generally an improved design over puffer-type circuit breakers, which rely solely on a piston-driven chamber which release a “puff” of gas to the interrupting space. The puffer-breakers are mechanically driven by separation of the contacts.

In typical gas-blast circuit breaker designs, electric current normally flows through the contacts of the circuit breaker interrupter module when the contacts of the circuit breaker are in a closed position. When commanded by appropriate control circuitry, this interrupter module begins to open its internal arcing contacts with one contact moving while the other contact remains fixed. As the contacts separate, an electrical arc is initiated and propagates between the separating arcing contacts. When the contacts are closed, this arc is maintained by the electric system driving voltage and the inductive nature of the system that induces the current to flow.

In many gas-blast interrupter designs, a volume of gas is maintained at pressure and/or delivered under pressure controllably by the motion of the interrupter contacts. The cooling behavior of this gas flow is used to cool and extinguish the electric arc, usually at an ensuing zero-crossing of the power frequency electric current, thus allowing the contacts to open and safely interrupt the current. The pressure that drives this gas flow may be achieved by various means, such as compression of an initial gas volume by the motion of the contacts, or by using thermal energy from the electrical arcing to raise the temperature and pressure of a gas volume designed to receive that energy, by a combination of both mechanical and thermal means, or by some other means.

High voltage circuit breakers are required to interrupt more than one time to meet their designated rating. Circuit breaker ratings include the capability to perform a so-called “duty cycle”, in which the circuit breaker must interrupt a current flow several times in succession, with time intervals dictated by industry standards or user specifications. Typically, a circuit breaker might be required to interrupt successive fault currents, or short circuits on an electrical power system with as little as 15 to 20 electrical cycles between them (e.g., 250 milliseconds to 300 milliseconds). This short time interval is especially important for circuit breakers that are rated for high-speed re-closing duty, for quick restoration of electrical current flow on the power grid.

Gas-blast circuit interrupters use pressurized gas to drive gas flow for interruption of the arc. In many designs, the process of developing/delivering this gas also heats the residual gas in the interrupter arcing contact zone, which also reduces its mass density. The arcing process also can pollute the zone adjacent to and surrounding the arcing contacts with arcing by-products, such as conductive particles that form from the arc heating the contacts. Both of these effects can reduce the capability of the interrupter to perform its function until the residual gas quality is restored. Also, following the cooling process at the electrical arcing contact zone, during which the flowing gas absorbs thermal energy and arc by-products, the gas flow continues through the interrupter module into areas of the design intended to cool and dissipate the exhaust gas.

Many gas-blast interrupter designs incorporate a re-filling capability, such that after an initial interruption event that accompanies the opening of the interrupter contacts, the breaker gas volumes in the interrupter space are re-filled during the ensuing closing operation of the interrupter contacts. This closing operation must occur before another fault interruption can be carried out. The re-filling of the gas is typically driven by mechanical compression during the closing of the contacts. A channel to one or more of the gas chambers located away from the interrupter space is opened and gas flows into the chambers upon the closing of the circuit. This pressure-driven re-fill process is typically accomplished by the design of a specialized re-fill valve assembly, which is then incorporated into the circuit breaker interrupter module.

In prior art designs, the design of the re-fill valve has sourced the gas from areas that are close to the exhaust outlets of the internal gas flow of the interrupter contact system, internal to the interrupter module. The quality of the re-filling process is then limited by the quality of the gas at the source side of the re-fill valve design. The source location in these prior ar designs is typically away from the arcing contact zone of the interrupter.

Such designs may include the circuit breakers and re-fill valve assemblies described in U.S. Pat. Nos. 6,744,001; 4,650,941; and 6,624,371, the disclosures of which are each herein incorporated by reference in their entirety. For example in U.S. Pat. No. 6,624,371, the circuit breaker includes a separate compression chamber and interrupting chamber, with a discharge valve between them, such that pressurized gas in one chamber may be discharged towards the interrupting space. The circuit breaker of the '371 patent includes two channels through which gas may be discharged from the compression (piston-driven) chamber and the interrupting (thermal blast) chamber. In one embodiment, if the current being interrupted is high, the discharge valve allows the gases to be discharged through one channel from the piston-driven chamber towards a space that is downstream from the arc. After the piston-driven chamber is emptied, on current zero, the gas in the thermal blast valve is blasted through the second channel onto the root of the electric arc.

U.S. Pat. No. 6,744,001 describes a circuit breaker including two contacts disposed in a breaking space which is delimited by a blast nozzle and contains a dielectric gas, the circuit-breaker including a thermal blast chamber which communicates with the breaking space via a throat of the nozzle and with an expansion space via an evacuation passage adapted to be shut off by a valve. The valve is adapted to open when the, pressure in the thermal blast chamber is greater than a particular threshold to evacuate the pressurized gas from the chamber. The prior art circuit breaker is characterized in that the evacuation passage is formed in the nozzle and defines a circular volume within the thickness of the nozzle, following the general shape thereof, and opening into the expansion space downstream of the breaking space relative to the throat. The prior art thermal blast chamber is heated by the arcing in the interrupting space, causing the gas to pressurize. In order to cool the gas to an appropriate temperature to accomplish the extinction, a valve opens such that a quantity of gas may be relaxed into the evacuation passage, which empties hot gas downstream of the interrupting space. Once a portion of the gas is released into the evacuation passage, the gas in the thermal blast chamber is then blasted onto the interrupting space.

Similarly, in U.S. Pat. No. 4,517,425 a circuit breaker includes a thermal blast chamber which communicates with the interrupting space via the throat of a nozzle and with an expansion space through passages closed by valves. In one particular embodiment of the circuit breaker, at least one of the valves is an evacuation valve adapted to open when the pressure in the thermal blast chamber is greater than a particular threshold to evacuate pressurized gas from the chamber to the expansion space. This construction increases the breaking capacity because the valve opens to depressurize the chamber if the pressure in the thermal blast chamber becomes too high. This depressurization decreases the temperature, which guarantees that the gas blown into the breaking space has a satisfactory dielectric strength.

These prior art circuit breakers typically rely on the pressure-driven flow of the dielectric gas within the interior cavity of the interrupter. These designs utilize multiple channels and/or multiple pressurizing chambers to harness, pressurize and recycle the gas. A piston-driven chamber releases gas into a thermal blast chamber that collects the dielectric gas used to extinguish the arc upon the movement/retraction of the contacts upon circuit opening. Additionally, after the pressurized gas is released to the interrupter space, these two chambers are refilled by the flow of gas through the interior cavity, usually via a separate refill channel. The pressurized gas blasted onto the arc cools the interrupting space, forcing the hot gas out of the interrupting space. This exhaust gas may be channeled from the interrupter space to other areas of the interior cavity. Some of the exhaust gas thus refills the chambers, which is then reused as blasting gas. There are problems associated with using the exhaust gas as the source for the pressurized gas, as explained above. Therefore, it is desirable to refill the chamber with cleaner gas and more quickly recycle the gas to be blasted across the interrupter space.

Therefore, it is desirable to provide an improved circuit breaker with re-fill valve and system which efficiently delivers pressurized gas and recycles gas to be used to interrupt the arc.

### SUMMARY

In accordance with one embodiment, a circuit breaker includes a contact mechanism movable between an open and closed positions, wherein the contact mechanism comprises at least two contacts disposed in an interrupting space, wherein in the open position a pressurized gas blasts an electric arc between the contacts, a driving mechanism operable to drive the contact mechanism between the open and closed positions, at least one chamber that pressurizes the gas to be blasted onto the electric arc; and a nozzle that communicates with the chamber and through which the pressurized gas is delivered onto the electric arc, wherein the nozzle comprises a refill valve having a plurality of controllable openings to draw a volume of gas from the interrupting space to be reused as pressurized gas.

In accordance with another embodiment, a circuit breaker assembly includes a puffer chamber having a nozzle extending from an end, a vent located at or near the end of the puffer chamber, and a vent seal movably positioned inside the puffer chamber and over the vent. The assembly may also include a flexible member positioned between the vent seal and the end of the puffer chamber. The vent seal may prevent gas from escaping through the vent when the puffer chamber is under pressure, and it may permit gas to enter the puffer chamber when the puffer chamber is not under pressure or is at a negative pressure. The puffer chamber may be positioned in a circuit breaker so that the nozzle delivers an insulating medium to an interrupting space when the breaker contacts are opened, and so that the chamber receives an insulating medium into the puffer chamber when the breaker contacts is closing.

In another embodiment, a circuit breaker assembly includes a pair of interrupting contacts positioned in an interruption chamber. A puffer chamber has a nozzle that is directed to deliver an insulating material to the interruption chamber when the contacts are opened. The puffer chamber may include a refill valve positioned to receive the insulating material when the contacts are closing. The refill valve may include a vent located on an exterior wall of the puffer chamber, and a seal movably positioned over the vent. The refill valve may also include a flexible member positioned between the seal and the wall so that the seal covers the vent when the chamber is under an elevated pressure, and the seal does not cover the vent when the chamber is not under an elevated pressure. The seal may cover the vent when the chamber is under an elevated pressure, and the seal may not completely cover the vent when the chamber is not under elevated pressure or is at a negative pressure.

In another embodiment, a circuit breaker puffer chamber includes a vessel for holding an insulating material, a nozzle extending from an end and positioned to expel the insulating material from the vessel when the vessel is subject to a positive pressure, a vent located on a wall of the vessel and positioned to receive insulating material into the vessel when the vessel is not subject to the pressure; and a vent seal positioned to cover the vent when the vessel is subject to the pressure. The vent may include a plurality of openings. The seal may include a rigid member positioned over the plurality of openings. The chamber may also include a flexible member positioned between the rigid member and the wall. Optionally, the wall may be the end of the vessel from which the nozzle extends, and the vent may include a plurality of openings positioned around the nozzle. The seal may include a rigid member positioned inside the vessel over the plurality of openings, and a flexible member positioned between the rigid member and the wall.

### BRIEF DESCRIPTION OF THE DRAWINGS

Various aspects and applications of the present invention will become apparent to the skilled artisan upon consideration of the brief description of the figures and the detailed description of the invention, which follows:

FIG. 1 is a sectional view showing an embodiment of a high-voltage circuit breaker in a closed position.

FIG. 2 is a sectional side view of the circuit breaker of FIG. 1 in an open position.

FIG. 3 is a perspective view of a puffer chamber, nozzle and refill valve assembly.

FIG. 4 is a view of an end wall of a puffer chamber.

FIG. 5 is a view of an exemplary puffer chamber vent seal.

FIG. 6 provides a detailed view of an interrupting: chamber, contacts and gas delivery space.

### DETAILED DESCRIPTION

Before the present devices and methods are described, it is to be understood that this invention is not limited to the particular designs, processes, compositions, or methodologies described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an” and “the” include the plural reference unless the context clearly dictates otherwise. Thus, for example, reference to a “contact” is a reference to one or more contacts and equivalents thereof known to those skilled in the art, and so forth. Unless defined otherwise, all technical and scientific terms used herein have the same meanings as commonly understood by one of ordinary skill in the art, All publications mentioned herein are incorporated by reference in their entirety. Nothing herein is to be construed as an admission that the invention is not entitled to antedate such disclosure by virtue of prior invention.

An embodiment relates to a re-fill gas circuit breaker valve that, by its novel design and placement, may improve the quality of the gas sourced during the refill of the interrupter volumes during the closing of the electrical contacts. The improvement of the re-fill gas quality may result in improved interrupting capability during ensuing interruption events, after the first such event.

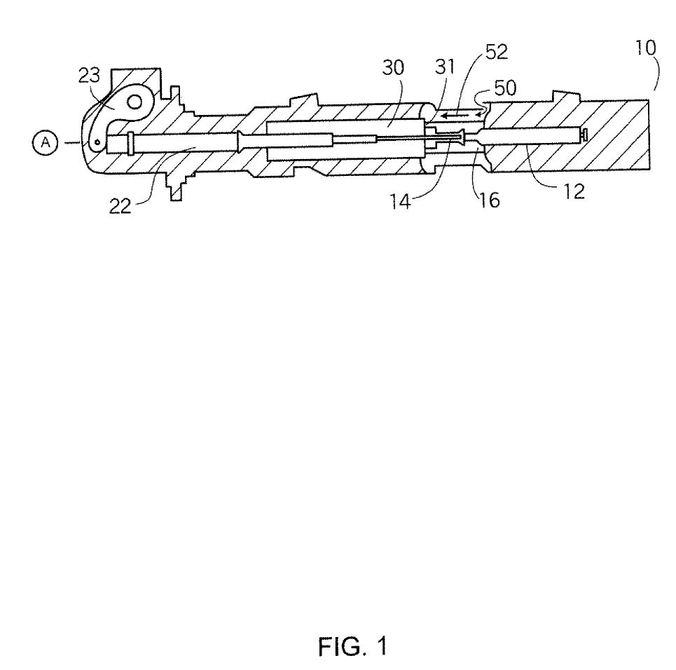

A typical gas-blast circuit breaker may have a generally cylindrical or other shape with two end plates or other structures to provide a sealed tank interrupter. FIG. 1 is a sectional view of exemplary components of such an interrupter 10. The interrupter is shown in a closed position, as a stationary contact 12 and movable contact 14 are touching in the interrupting chamber 16. An interior cavity or vessel 305 known as a puffer chamber, of the breaker may be insulated with an insulating and arc quenching medium, such as SF₆, or some other appropriate gas.

The stationary 12 and movable 14 contact assembly may be cooperatively configured for relative movement. A drive rod 22 or similar linkage may be used to move the movable contact assembly selectively between open and closed circuit positions along axis A. The drive rod 22 may include any suitable mechanism to move the movable assembly 14 between its positions, including pneumatic and hydraulic systems, cam-spring systems, and the like. For example, a bell crank may drive a rotating lever 23, which moves drive rod 22 in one direction or another. The movable 14 and stationary 12 contact assemblies may be shaped in a suitable configuration, such as male and female assemblies operatively connected in the closed position.

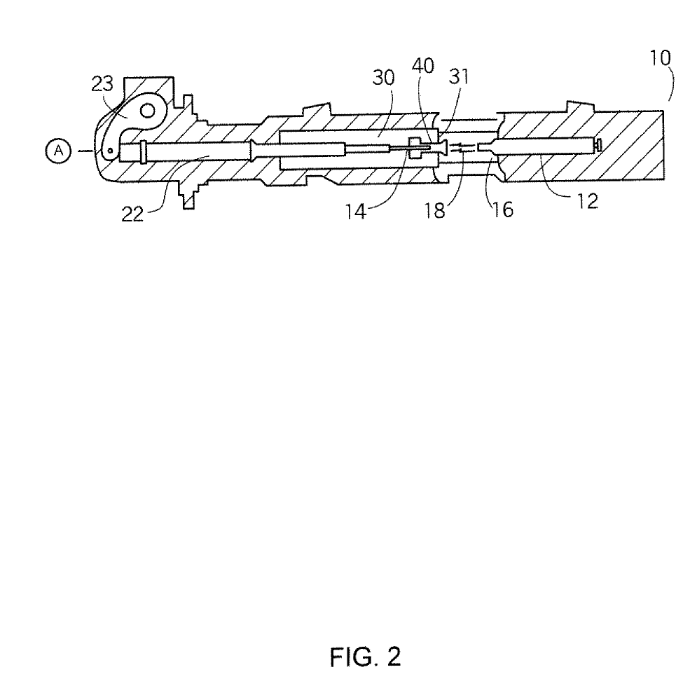

Referring to FIG. 2, a circuit may be interrupted when drive rod 22 pulls or moves movable contact 14 away from stationary contact 12. When this occurs, an arc 18 may form between movable contact 14 and stationary contact 12.

To increase the likelihood of interruption between the contacts during breaking of the circuit, the contact assembly may be designed to provide a puff of the insulating gas into the interrupting space 16 between the separated contacts. This may be accomplished through the use of a puffer chamber 30 that becomes compressed by the relative motion of the movable contact 14 away from stationary contact 12. If the chamber is compressed, the volume of the insulating medium within the chamber is decreased and thus its pressure is increased. The pressurized insulating medium may escape from the puffer chamber 30 through a nozzle 40 or other delivery device and thus be blasted or puffed into the interrupting space 16 or arcing area to enhance cooling and arc reduction.

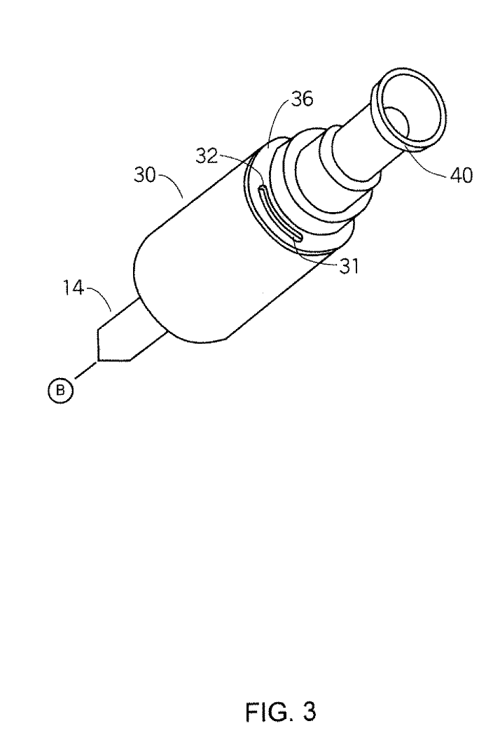

FIG. 3 illustrates a more detailed schematic of an exemplary puffer chamber vessel 30, vent 31, nozzle 40 and movable contact 14. Puffer chamber vessel 30 is sealed to hold insulating gas, and one or more vents 31 may be located on an end 36 of the chamber 30 that faces or is near the interrupting chamber 16 (see FIG. 1). Alternatively, one or more of the vents 31 may be located on a wall of the vessel at a location that is relatively close to the end. A seal 32, which may be, for example a ring, flange or other member that is interior to chamber 30 and covers vent 31, may be positioned inside chamber 30 to form a valve. One or more springs or other flexible members may be located between seal 32 and the interior walls of vessel 30 so that gas may enter chamber 30 through vent 31 when the pressure inside vessel 30 is low, but so that the seal covers the vent when the pressure in the vessel exceeds a desired level. Alternatively, seal 32 may be rounded and/or made of a flexible material that flattens and covers vent 31 under elevated pressure, but which moves and allows gas to enter via vent 31 when the pressure is not elevated.

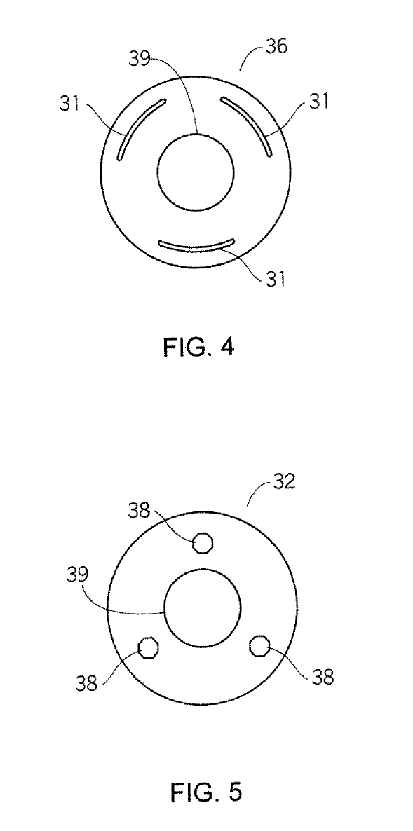

FIG. 4 provides a view of am exemplary interior end wall 36 of puffer chamber 30 from the perspective of point B in FIG. 3 along the shaft of movable contact 14. Referring to FIG. 4, end wall 36 may include any number of vents 31 through which gas may enter the chamber end wall 36 may also include an opening 39 to accept the nozzle.

Referring to FIG. 5, seal 32 may include a metal ring with any number of springs 38 or other flexible support members between seal 32 and the end wall 36 of vessel 30. When the vessel 30 is under pressure, seal 32 is pressed against chamber wall 36 so that gas does not escape through the vent or vents (31 in FIG. 3 or 4) located on chamber wall 36 and under seal 32. When this occurs, gas may be forced into an interrupting chamber through a nozzle across opening 39. However, when the vessel 30 is under reduced or negative pressure, gas may enter chamber from the vents under seal 32, as springs or support members 38 will allow seal 32 to move away from the wall 36.

Referring again to FIG. 2, when the contacts are separated puffer chamber 30 is compressed, and the insulating material is forced from puffer chamber 30 through nozzle 40 into interruption chamber 16. As used herein, the term “nozzle” includes any pipe, opening, or other structure through which an insulating material may be expelled from the puffer chamber vessel 30.

After the “blast.” the chamber may be relatively free of gas. When the contacts are subsequently closed and the volume of puffer chamber 30 expands, the refill valve vent 31 delivers cool clean gas 5S into the puffer chamber 30. As the contacts expand, pressure is reduced in the chamber. In fact, because the chamber is relatively gas-free after contact opening, contact closing may create a vacuum or negative pressure in the chamber. Therefore, the refill valve acts to suction gas from the unperturbed interrupter space back into the puffer chamber as the contacts close. The pressure differential created by the closing of the contacts and increase in puffer volume allows for such refilling of the chamber without the need for forced delivery of gas in the chamber.

Thus, the nozzle, puffer chamber and refill valve may be incorporated into any suitable circuit breaker. Suitable circuit breaker designs may include, for example any of the elements described in U.S. Pat. Nos. 3,852,548; 4,650,941; 6,307,172; 6,744,001; 6,686,553; 6,43727,26; 4,027,125; 6,624,371; and 4,517,425, each herein incorporated by reference in their entireties.

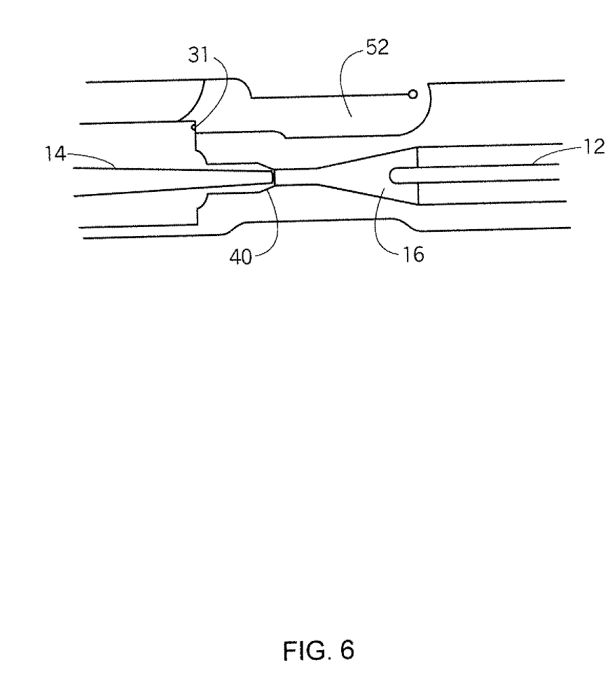

Referring to FIG. 6, the refill valve may be located on the arcing contact side of the gas volume, so as to draw gas from the “clean” volume area 52 surrounding the open gap of the interrupter. The volume surrounding the open gap of the interrupter is also known as the “interrupter space” 16. The interrupter space 16 is typically not a recipient of the exhaust gas flow, as it must be kept cool and clean to withstand voltage after the interruption event as movable contact 14 moves away from stationary contact 12. The exhaust gas, as explained above, may be forced from the interrupter space through nozzle 40 by the blast of pressurized gas. In this manner, any particles that are created by the arc, such as conductive particles that are burned off of the contacts themselves, would not be in the gas that is drawn through the refill valve. Any conductive particles may be managed by a suitable particle trap design, such as the one described in U.S. Pat. No. 6,307,172, herein incorporated by reference in its entirety.

The refill valve may be incorporated into an interrupter module or into a circuit breaker. Any medium or high voltage circuit breaker that utilizes a gas-blast interrupter design to interrupt electrical current arcs may be designed with a re-fill valve as described above. The circuit breaker may be rated to be able to carry out several short circuit cu-rent interruptions in short succession, as defined in industry standards for high-speed re-closing duty.

The refill valve assembly may be incorporated into high voltage circuit breakers that are required to interrupt more than one time to meet a designated rating. Circuit breaker ratings include the capability to perform a so-called “duty cycle”, in which the circuit breaker must interrupt several times in succession, with time intervals dictated by industry standards or user specifications. Typically, a circuit breaker might be required to interrupt successive fault currents (faults are short circuits on an electrical power system) with as little as 15 to 20 electrical cycles between them (250 milliseconds to 300 milliseconds). This short time interval is especially important for circuit breakers that are rated for high-speed “re-closing” duty, for quick restoration of electrical current flow on the power grid. The refill valve assembly allows for quick successions of the open and closed positions, since the pressurized gas is sourced from a clean and cool area, instead of from hot exhaust gas. The circuit breaker thus utilizes a gas re-fill process to restore the quality of the gas in the internal puffer chamber so as to improve electrical current interruption capability for electrical current interruptions following the first of several in its rated duty cycle.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art, each of which are also intended to be encompassed by the following claims.

What is claimed is:

1. A circuit breaker assembly, comprising:
a puffer chamber having a nozzle extending from an end thereof;
a refill valve, wherein the refill valve comprises:
a vent defined by the puffer chamber and located proximate the end of the puffer chamber; and
a vent seal aligned with the vent and movably positioned inside the puffer chamber;
an interrupting chamber surrounding the nozzle; and
an enclosed volume surrounding the interrupting chamber, wherein the refill valve is positioned such that the refill valve allows a non-exhaust gas from the enclosed volume into the puffer chamber when a first contact of the circuit breaker assembly is moving toward a second contact of the circuit breaker assembly.

2. The assembly of claim 1 further comprising a flexible member connected to the vent seal and positioned between the vent seal and the end of the puffer chamber.

3. The assembly of claim 1, wherein;
the vent seal prevents the non-exhaust gas within the puffer chamber from escaping through the vent when the puffer chamber is under pressure; and
the vent seal permits the non-exhaust gas from the enclosed volume to enter the puffer chamber when at least one of the following puffer chamber environment exits:
the puffer chamber is not under pressure; and
the puffer chamber is under negative pressure.

4. The assembly of claim 1 wherein the puffer chamber is positioned in the circuit breaker assembly so that the nozzle delivers the non-exhaust gas from the puffer chamber to the interrupting chamber when the first contact is moving from the second contact.

5. The assembly of claim 1 wherein the puffer chamber is positioned to receive the non-exhaust gas from the enclosed volume into the puffer chamber when the first contact is moving toward the second contact.

6. The assembly of claim 2 wherein the vent seal comprises a ring, and the flexible member comprises a spring.

7. A circuit breaker assembly, comprising:
a pair of interrupting contacts positioned in an interruption chamber;
a puffer chamber having a nozzle, wherein the nozzle is directed to deliver a non-exhaust gas from the puffer chamber to the interruption chamber when one of the contacts is moving away from the other contact;
wherein the puffer chamber includes a refill valve positioned to receive the non-exhaust gas from an enclosed volume which surrounds the interruption chamber when the one of the contacts is moving toward the other contact.

8. The assembly of claim 7, wherein the refill valve comprises:
a vent located on an exterior wall of the puffer chamber; and
a seal aligned with the vent and movable inside the puffer chamber.

9. The assembly of claim 8 wherein the refill valve further comprises a flexible member connected to the vent seal and positioned between the seal and the wall so that the seal covers the vent when the chamber is under pressure, and the seal does not cover the vent when the chamber is not under pressure.

10. The assembly of claim 8 wherein the seal covers the vent when the chamber is under pressure, and the seal does not completely cover the vent when the chamber is at a negative pressure.

11. A circuit breaker puffer chamber comprising:
a vessel;
a nozzle extending from an end of the vessel and positioned to expel a non-exhaust gas from the vessel into an interruption chamber when the vessel is subject to a pressure;
a vent defined by a wall of the vessel and positioned to receive the non-exhaust gas from an enclosed volume into the vessel when the vessel is not subject to the pressure, wherein the enclosed volume surrounds the interruption chamber; and
a vent seal positioned to cover the vent when the vessel is subject to the pressure.

12. The chamber of claim 11, wherein:
the vent comprises a plurality of openings;
the seal comprises a rigid member positioned over the plurality of openings defined by the wall; and the chamber further comprises a flexible member connected to the seal and positioned between the rigid member and the wall.

13. The chamber of claim 11, wherein the wall comprises the end of the vessel from which the nozzle extends.

14. The chamber of claim 11, wherein the vent comprises a plurality of openings defined by the wall and positioned around the nozzle.

15. The chamber of claim 14, wherein:
the seal comprises a rigid member positioned inside the vessel over the plurality of openings; and
the chamber further comprises a flexible member connected to the seal and positioned between the rigid member and the wall.

16. The chamber of claim 11 wherein the non-exhaust gas comprises sulfur hexafluoride.

17. A circuit breaker assembly, comprising:
a stationary contact;
a movable contact assembly aligned with the stationary contact, the movable contact assembly comprising:
a vessel,
a nozzle connected to an end of the vessel; and
a movable contact positioned within at least one of the following:
the vessel; and
the nozzle, and
a refill valve, wherein the refill valve comprises;
a vent defined by the vessel and positioned proximate the end of the vessel; and
a vent seal aligned with the vent and movable inside the vessel;
an interrupting chamber surrounding the nozzle; and
an enclosed volume surrounding the interrupting chamber, wherein the refill valve is positioned such that the refill valve allows a non-exhaust gas from the enclosed volume into the vessel when the movable contact assembly is moving toward the stationary contact.

18. A method, comprising:
delivering a gas from a puffer chamber of a circuit breaker assembly to an interrupting chamber of a circuit breaker assembly when a first contact of the circuit breaker assembly is moving away from a second contactor of a circuit breaker assembly;
exhausting the gas from the interrupting chamber;
delivering a non-exhaust gas from an enclosed volume of a circuit breaker assembly which surrounds the interrupting chamber to the puffer chamber when the first contact is moving toward the second contact; and
delivering the non-exhaust gas from the puffer chamber to the interrupting chamber when the first contact is moving away from the second contact.

19. The method of claim 18, wherein delivering the gas from the puffer chamber to the interrupting chamber includes delivering the gas from the puffer chamber to the interrupting chamber via a nozzle connected to an end of the puffer chamber.

20. The method of claim 18, wherein delivering the non-exhaust gas from the enclosed volume to the puffer chamber includes delivering the non-exhaust gas from the enclosed volume to the puffer chamber via a refill valve positioned proximate the end of the puffer chamber.
